(19) United States
(12) Patent Application Publication
(10) Pub. No.: US 2009/0251441 A1
(43) Pub. Date: Oct. 8, 2009

(54) Multi-Modal Controller

(75) Inventors: Tracy L. Edgecomb, Berkeley, CA (US); Jam Marggraff, Lafayette, CA (US); Alexander Sasha Pesic, San Ramon, CA (US)

Correspondence Address: FENWICK & WEST LLP, SILICON VALLEY CENTER, 801 CALIFORNIA STREET, MOUNTAIN VIEW, CA, 94041, US

(73) Assignee: LIVESCRIBE, INC., Oakland, CA (US)

(21) Appl. No.: 12/415,780

(22) Filed: Mar. 31, 2009

Related U.S. Application Data
(60) Provisional application No. 61/042,207, filed on Apr. 3, 2008.

(51) Int. Cl. G06F 3/033

(52) U.S. Cl. 345/179; 715/863

(57) ABSTRACT

Control inputs are provided to an application executing on a mobile computing device by moving the mobile computing device in certain recognizable patterns. The control inputs may execute various functions in the application such as starting or stopping audio playback or navigating through a menu. A writing gesture made by a user on a writing surface using a smart pen device is digitally captured. This gesture may be, for example, a tap or a stroke of the smart pen device on the writing surface. A control on the writing surface is identified, where the control at least partially corresponds to a location of the writing gesture on the writing surface. A control input is determined based on the identified control and the writing gesture. Responsive to the control input, a command is executed in an application running on the smart pen device or an attached computing system.

### CROSS REFERENCE TO RELATED APPLICATIONS

This application claims the benefit of U.S. Provisional Application No. 61/042,207, filed Apr. 3, 2008, which is incorporated by reference in its entirety.

### BACKGROUND

This invention relates generally to pen-based computing systems, and more particularly to expanding range of inputs to a pen-based computing system.

It is desirable for a mobile computing device to be able to support a wide variety of applications and to be usable in almost any environment. However, the mobile computing device may have limited input devices due to its size or form factor. For example, the mobile computing device may have only a single user-accessible button and an imaging device as its input devices. The mobile computing device may also have limited output devices to assist with user input, such as having only a single, small, liquid crystal display (LCD). Despite the limited input and output devices, the user may want to perform many tasks, such as selecting functions, launching applications, viewing and responding to user dialogs, easily accessing real-time controls for a variety of features, and browsing the contents of the mobile computing device. The device should also be flexible and expandable to support new applications and features, including new input methods, that are added to the device over time.

Accordingly, there is a need for techniques that can expand the range of input available to a user of a mobile computing device.

### SUMMARY

Embodiments of the invention present a new way for a user to provide control inputs to an application executing on a mobile computing device (e.g., a smart pen) by moving the mobile computing device in certain recognizable patterns. The control inputs may execute various functions in the application such as starting or stopping audio playback or navigating through a menu. In one embodiment, a writing gesture made by a user on a writing surface using a digital pen device is digitally captured. This gesture may be, for example, a tap or a stroke of the digital pen device on the writing surface. A control on the writing surface is identified, where the control at least partially corresponds to a location of the writing gesture on the writing surface. A control input is determined based on the identified control and the writing gesture. Responsive to the control input, a command is executed in an application running on the digital pen device or an attached computing system.

Controls may be pre-printed on the writing surface or may have been created by a user. In one embodiment, a user-created control can be initialized by digitally capturing a writing gesture made on a writing surface using a digital pen device. It is recognized, based on the pattern of the writing gesture, that the writing gesture comprises a control. The type of control is determined based on the pattern of the writing gesture. The location of the control is determined based on the location of the gesture on the writing surface. The determined location and type of control is stored in a memory of the digital pen device.

### BRIEF DESCRIPTION OF THE DRAWINGS

FIG. 1 is a schematic diagram of a pen-based computing system, in accordance with an embodiment of the invention.

FIG. 2 is a diagram of a smart pen for use in the pen-based computing system, in accordance with an embodiment of the invention.

FIG. 3 illustrates an embodiment of a process for providing control inputs to a pen-based computing system.

FIG. 4 illustrates an embodiment of a process for recognizing and initializing a user-created control.

FIG. 5 illustrates an example of a sheet of dot-enabled paper for receiving control inputs through controls.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Overview of Pen-Based Computing System

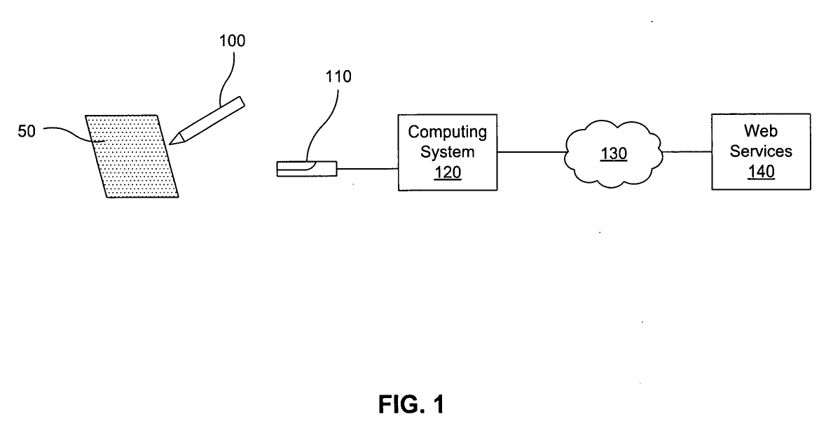

Embodiments of the invention may be implemented on various embodiments of a pen-based computing system, and other computing and/or recording systems. An embodiment of a pen-based computing system is illustrated in FIG. 1. In this embodiment, the pen-based computing system comprises a writing surface 50, a smart pen 100, a docking station 110, a client system 120, a network 130, and a web services system 140. The smart pen 100 includes onboard processing capabilities as well as input/output functionalities, allowing the pen-based computing system to expand the screen-based interactions of traditional computing systems to other surfaces on which a user can write. For example, the smart pen 100 may be used to capture electronic representations of writing as well as record audio during the writing, and the smart pen 100 may also be capable of outputting visual and audio information back to the user. With appropriate software on the smart pen 100 for various applications, the pen-based computing system thus provides a new platform for users to interact with software programs and computing services in both the electronic and paper domains.

In the pen based computing system, the smart pen 100 provides input and output capabilities for the computing system and performs some or all of the computing functionalities of the system. Hence, the smart pen 100 enables user interaction with the pen-based computing system using multiple modalities. In one embodiment, the smart pen 100 receives input from a user, using multiple modalities, such as capturing a user's writing or other hand gesture or recording audio, and provides output to a user using various modalities, such as displaying visual information or playing audio. In other embodiments, the smart pen 100 includes additional input modalities, such as motion sensing or gesture capture, and/or additional output modalities, such as vibrational feedback.

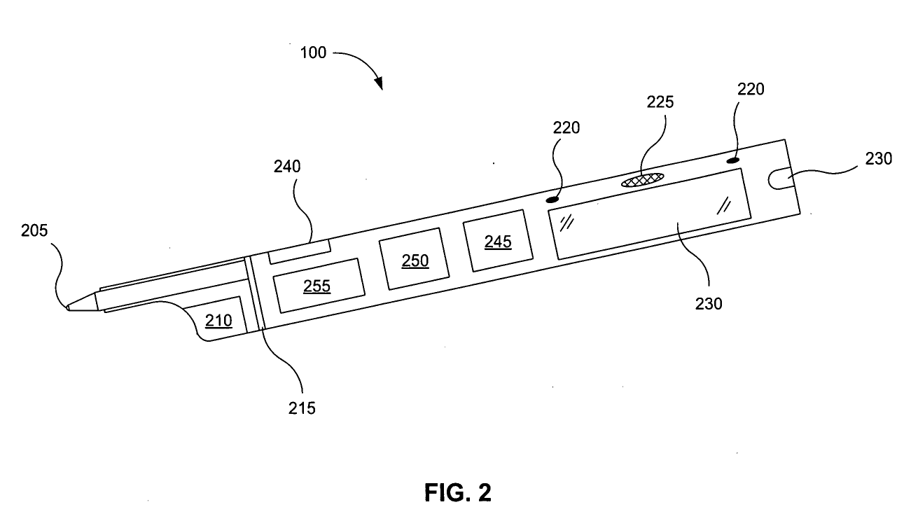

The components of a particular embodiment of the smart pen 100 are shown in FIG. 2 and described in more detail in the accompanying text. The smart pen 100 preferably has a form factor that is substantially shaped like a pen or other writing implement, although certain variations on the general shape may exist to accommodate other functions of the pen, or may even be an interactive multi-modal non-writing implement. For example, the smart pen 100 may be slightly thicker than a standard pen so that it can contain additional components, or the smart pen 100 may have additional structural features (e.g., a flat display screen) in addition to the structural features that form the pen shaped form factor. Additionally, the smart pen 100 may also include any mechanism by which a user can provide input or commands to the smart pen computing system or may include any mechanism by which a user can receive or otherwise observe information from the smart pen computing system.

The smart pen 100 is designed to work in conjunction with the writing surface 50 so that the smart pen 100 can capture writing that is made on the writing surface 50. In one embodiment, the writing surface 50 comprises a sheet of paper (or any other suitable material that can be written upon) and is encoded with a pattern that can be read by the smart pen 100. An example of such a writing surface 50 is the so-called “dot-enabled paper” available from Anoto Group AB of Sweden (local subsidiary Anoto, Inc. of Waltham, Mass.), and described in U.S. Pat. No. 7,175,095, incorporated by reference herein. This dot-enabled paper has a pattern of dots encoded on the paper. A smart pen 100 designed to work with this dot enabled paper includes an imaging system and a processor that can determine the position of the smart pen's writing tip with respect to the encoded dot pattern. This position of the smart pen 100 may be referred to using coordinates in a predefined “dot space,” and the coordinates can be either local (i.e., a location within a page of the writing surface 50) or absolute (i.e., a unique location across multiple pages of the writing surface 50).

In other embodiments, the writing surface 50 may be implemented using mechanisms other than encoded paper to allow the smart pen 100 to capture gestures and other written input. For example, the writing surface may comprise a tablet or other electronic medium that senses writing made by the smart pen 100. In another embodiment, the writing surface 50 comprises electronic paper, or e-paper. This sensing may be performed entirely by the writing surface 50 or in conjunction with the smart pen 100. Even if the role of the writing surface 50 is only passive (as in the case of encoded paper), it can be appreciated that the design of the smart pen 100 will typically depend on the type of writing surface 50 for which the pen based computing system is designed. Moreover, written content may be displayed on the writing surface 50 mechanically (e.g., depositing ink on paper using the smart pen 100), electronically (e.g., displayed on the writing surface 50), or not at all (e.g., merely saved in a memory). In another embodiment, the smart pen 100 is equipped with sensors to sensor movement of the pen's tip, thereby sensing writing gestures without requiring a writing surface 50 at all. Any of these technologies may be used in a gesture capture system incorporated in the smart pen 100.

In various embodiments, the smart pen 100 can communicate with a general purpose computing system 120, such as a personal computer, for various useful applications of the pen based computing system. For example, content captured by the smart pen 100 may be transferred to the computing system 120 for further use by that system 120. For example, the computing system 120 may include management software that allows a user to store, access, review, delete, and otherwise manage the information acquired by the smart pen 100. Downloading acquired data from the smart pen 100 to the computing system 120 also frees the resources of the smart pen 100 so that it can acquire more data. Conversely, content may also be transferred back onto the smart pen 100 from the computing system 120. In addition to data, the content provided by the computing system 120 to the smart pen 100 may include software applications that can be executed by the smart pen 100.

The smart pen 100 may communicate with the computing system 120 via any of a number of known communication mechanisms, including both wired and wireless communications. In one embodiment, the pen based computing system includes a docking station 110 coupled to the computing system. The docking station 110 is mechanically and electrically configured to receive the smart pen 100, and when the smart pen 100 is docked the docking station 110 may enable electronic communications between the computing system 120 and the smart pen 100. The docking station 110 may also provide electrical power to recharge a battery in the smart pen 100.

FIG. 2 illustrates an embodiment of the smart pen 100 for use in a pen based computing system, such as the embodiments described above. In the embodiment shown in FIG. 2, the smart pen 100 comprises a marker 205, an imaging system 210, a pen down sensor 215, one or more microphones 220, a speaker 225, an audio jack 230, a display 235, an I/O port 240, a processor 245, an onboard memory 250, and a battery 255. It should be understood, however, that not all of the above components are required for the smart pen 100, and this is not an exhaustive list of components for all embodiments of the smart pen 100 or of all possible variations of the above components. For example, the smart pen 100 may also include buttons, such as a power button or an audio recording button, and/or status indicator lights. Moreover, as used herein in the specification and in the claims, the term “smart pen” does not imply that the pen device has any particular feature or functionality described herein for a particular embodiment, other than those features expressly recited. A smart pen may have any combination of fewer than all of the capabilities and subsystems described herein.

The marker 205 enables the smart pen to be used as a traditional writing apparatus for writing on any suitable surface. The marker 205 may thus comprise any suitable marking mechanism, including any ink-based or graphite-based marking devices or any other devices that can be used for writing. In one embodiment, the marker 205 comprises a replaceable ballpoint pen element. The marker 205 is coupled to a pen down sensor 215, such as a pressure sensitive element. The pen down sensor 215 thus produces an output when the marker 205 is pressed against a surface, thereby indicating when the smart pen 100 is being used to write on a surface.

The imaging system 210 comprises sufficient optics and sensors for imaging an area of a surface near the marker 205. The imaging system 210 may be used to capture handwriting and gestures made with the smart pen 100. For example, the imaging system 210 may include an infrared light source that illuminates a writing surface 50 in the general vicinity of the marker 205, where the writing surface 50 includes an encoded pattern. By processing the image of the encoded pattern, the smart pen 100 can determine where the marker 205 is in relation to the writing surface 50. An imaging array of the imaging system 210 then images the surface near the marker 205 and captures a portion of a coded pattern in its field of view. Thus, the imaging system 210 allows the smart pen 100 to receive data using at least one input modality, such as receiving written input. The imaging system 210 incorporating optics and electronics for viewing a portion of the writing surface 50 is just one type of gesture capture system that can be incorporated in the smart pen 100 for electronically capturing any writing gestures made using the pen, and other embodiments of the smart pen 100 may use any other appropriate means for achieve the same function.

In an embodiment, data captured by the imaging system 210 is subsequently processed, allowing one or more content recognition algorithms, such as character recognition, to be applied to the received data. In another embodiment, the imaging system 210 can be used to scan and capture written content that already exists on the writing surface 50 (e.g., and not written using the smart pen 100). The imaging system 210 may further be used in combination with the pen down sensor 215 to determine when the marker 205 is touching the writing surface 50. As the marker 205 is moved over the surface, the pattern captured by the imaging array changes, and the user's handwriting can thus be determined and captured by a gesture capture system (e.g., the imaging system 210 in FIG. 2) in the smart pen 100. This technique may also be used to capture gestures, such as when a user taps the marker 205 on a particular location of the writing surface 50, allowing data capture using another input modality of motion sensing or gesture capture.

Another data capture device on the smart pen 100 are the one or more microphones 220, which allow the smart pen 100 to receive data using another input modality, audio capture. The microphones 220 may be used for recording audio, which may be synchronized to the handwriting capture described above. In an embodiment, the one or more microphones 220 are coupled to signal processing software executed by the processor 245, or by a signal processor (not shown), which removes noise created as the marker 205 moves across a writing surface and/or noise created as the smart pen 100 touches down to or lifts away from the writing surface. In an embodiment, the processor 245 synchronizes captured written data with captured audio data. For example, a conversation in a meeting may be recorded using the microphones 220 while a user is taking notes that are also being captured by the smart pen 100. Synchronizing recorded audio and captured handwriting allows the smart pen 100 to provide a coordinated response to a user request for previously captured data. For example, responsive to a user request, such as a written command, parameters for a command, a gesture with the smart pen 100, a spoken command or a combination of written and spoken commands, the smart pen 100 provides both audio output and visual output to the user. The smart pen 100 may also provide haptic feedback to the user.

The speaker 225, audio jack 230, and display 235 provide outputs to the user of the smart pen 100 allowing presentation of data to the user via one or more output modalities. The audio jack 230 may be coupled to earphones so that a user may listen to the audio output without disturbing those around the user, unlike with a speaker 225. Earphones may also allow a user to hear the audio output in stereo or full three-dimensional audio that is enhanced with spatial characteristics. Hence, the speaker 225 and audio jack 230 allow a user to receive data from the smart pen using a first type of output modality by listening to audio played by the speaker 225 or the audio jack 230.

The display 235 may comprise any suitable display system for providing visual feedback, such as an organic light emitting diode (OLED) display, allowing the smart pen 100 to provide output using a second output modality by visually displaying information. In use, the smart pen 100 may use any of these output components to communicate audio or visual feedback, allowing data to be provided using multiple output modalities. For example, the speaker 225 and audio jack 230 may communicate audio feedback (e.g., prompts, commands, and system status) according to an application running on the smart pen 100, and the display 235 may display word phrases, static or dynamic images, or prompts as directed by such an application. In addition, the speaker 225 and audio jack 230 may also be used to play back audio data that has been recorded using the microphones 220.

The input/output (I/O) port 240 allows communication between the smart pen 100 and a computing system 120, as described above. In one embodiment, the I/O port 240 comprises electrical contacts that correspond to electrical contacts on the docking station 110, thus making an electrical connection for data transfer when the smart pen 100 is placed in the docking station 110. In another embodiment, the I/O port 240 simply comprises a jack for receiving a data cable (e.g., Mini-USB or Micro-USB). Alternatively, the I/O port 240 may be replaced by a wireless communication circuit in the smart pen 100 to allow wireless communication with the computing system 120 (e.g., via Bluetooth, WiFi, infrared, or ultrasonic).

A processor 245, onboard memory 250, and battery 255 (or any other suitable power source) enable computing functionalities to be performed at least in part on the smart pen 100. The processor 245 is coupled to the input and output devices and other components described above, thereby enabling applications running on the smart pen 100 to use those components. In one embodiment, the processor 245 comprises an ARM9 processor, and the onboard memory 250 comprises a small amount of random access memory (RAM) and a larger amount of flash or other persistent memory. As a result, executable applications can be stored and executed on the smart pen 100, and recorded audio and handwriting can be stored on the smart pen 100, either indefinitely or until offloaded from the smart pen 100 to a computing system 120. For example, the smart pen 100 may locally stores one or more content recognition algorithms, such as character recognition or voice recognition, allowing the smart pen 100 to locally identify input from one or more input modality received by the smart pen 100.

In an embodiment, the smart pen 100 also includes an operating system or other software supporting one or more input modalities, such as handwriting capture, audio capture or gesture capture, or output modalities, such as audio playback or display of visual data. The operating system or other software may support a combination of input modalities and output modalities and manages the combination, sequencing and transitioning between input modalities (e.g., capturing written and/or spoken data as input) and output modalities (e.g., presenting audio or visual data as output to a user). For example, this transitioning between input modality and output modality allows a user to simultaneously write on paper or another surface while listening to audio played by the smart pen 100, or the smart pen 100 may capture audio spoken from the user while the user is also writing with the smart pen 100. Various other combinations of input modalities and output modalities are also possible.

In an embodiment, the processor 245 and onboard memory 250 include one or more executable applications supporting and enabling a menu structure and navigation through a file system or application menu, allowing launch of an application or of a functionality of an application. For example, navigation between menu items comprises a dialogue between the user and the smart pen 100 involving spoken and/or written commands and/or gestures by the user and audio and/or visual feedback from the smart pen computing system. Hence, the smart pen 100 may receive input to navigate the menu structure from a variety of modalities.

For example, a writing gesture, a spoken keyword, or a physical motion, may indicate that subsequent input is associated with one or more application commands. For example, a user may depress the smart pen 100 against a surface twice in rapid succession then write a word or phrase, such as “solve,” “send,” “translate,” “email,” “voice-email” or another predefined word or phrase to invoke a command associated with the written word or phrase or receive additional parameters associated with the command associated with the predefined word or phrase. This input may have spatial (e.g., dots side by side) and/or temporal components (e.g., one dot after the other). Because these “quick-launch” commands can be provided in different formats, navigation of a menu or launching of an application is simplified. The “quick-launch” command or commands are preferably easily distinguishable during conventional writing and/or speech.

Alternatively, the smart pen 100 also includes a physical controller, such as a small joystick, a slide control, a rocker panel, a capacitive (or other non-mechanical) surface or other input mechanism which receives input for navigating a menu of applications or application commands executed by the smart pen 100.

### Overview of Expanded Input Techniques

Embodiments of the invention present a new way for a user to provide control inputs to a mobile computing device by moving the mobile device in certain recognizable patterns. When a user makes gestures on dot-enabled paper with the smart pen 100, the gestures created by the user are normally provided as data inputs to an application running in the smart pen 100. For example, in a note-taking application, the user writes notes on the dot-enabled paper 50, and the notes are recorded by the imaging system of the smart pen and stored by the note-taking application. The smart pen 100 may also record and store audio while the notes are being taken. In addition to data inputs, the note-taking application may also accept certain control inputs by the user. For example, the user may provide a control input to tell the application to start recording. Other control inputs may allow the user to stop recording, to play back the recorded audio, to rewind or fast-forward the audio, or to switch to another application, for example. Control inputs may also be used to navigate through menus or access various smart pen features.

In one embodiment, controls are pre-printed at known locations on a writing surface 50. The user makes a gesture that is at least partially within a control. The gesture may involve tapping the smart pen 100 at a particular point in the control, placing the smart pen at a particular point in the control and holding it there, or making a stroke with the smart pen within the control. Various other types of gestures are possible. Based on the control and the gesture, the smart pen 100 determines a particular control input provided by the user. The smart pen 100 then performs an appropriate action, such as carrying out a command specified by the control input. In one embodiment, a user can draw a control using the smart pen at any arbitrary place on the writing surface 50. The smart pen 100 may automatically recognize a user-drawn control (also referred to as a user-created control), or the user may provide a further input to identify the control to the smart pen.

The following discussion of various embodiments of the invention is presented with reference to the figures. FIG. 1 is a block diagram of an example architecture for providing control inputs to a smart pen computing system. FIG. 1 illustrates a piece of dot-enabled paper 50 and a smart pen 100 that can be used in conjunction with the paper 50. The operations described below may be performed by an application running on the processor of the pen 100, by an application running on an attached computing system 120, or a combination of the two.

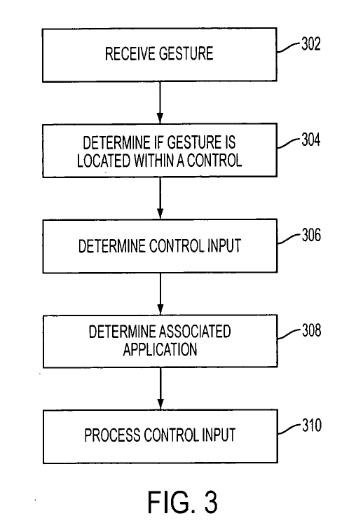

FIG. 3 illustrates an embodiment of a process for providing control inputs to a pen-based computing system. In this process, the smart pen 100 of the pen-based computing system receives 302 a gesture made by a user on dot-enabled paper 50. This gesture is received by the imaging system 210 of the smart pen and the location of the gesture relative to the dot pattern is determined. The pen-based computing system determines 304 if the location of the gesture is within part of a control, such as a pre-printed control or a user-created control. The smart pen 100 or attached computing system 120 stores the locations of various controls relative to the dot pattern and may compare the location of the gesture with the locations of the various controls to determine if the gesture is at least partially within a particular control.

If it is determined that the location of the gesture is not within a control, the smart pen 100 may pass the gesture to a currently running application as a data input (e.g., a note taking application that stores the gesture). If it is determined that the location of the gesture is within a control, the smart pen determines 306 a control input based on the gesture and the control. This control input may be determined based on the portion of the control where the gesture is made. The control input may also be determined based on a motion of the gesture, such as sliding the imaging system 210 of the smart pen 100 up and down a control (such as a slider control). The control input may be partially determined by the pen-down sensor 215, which can indicate, for example, the user tapping or double-tapping at a particular location on a control. The control input may also be determined based on inputs to the pen from other sources, such as the user pressing a button on the pen or providing an audio input through the microphone 220.

In one embodiment, the smart pen determines 308 a particular application associated with the control input. Some control inputs can apply to any application, while others are specific to one or a few applications. In one embodiment, the pen-based computing system stores an indication of the application(s) associated with each control. The use of application-specific controls is further described below. A control may also be associated with particular content as described below. The pen-based computing system then processes 310 the control input. This may involve executing a command for a particular application, such as starting playback of stored audio or selecting an item in a pen-based menu. The results of the command execution (e.g., an indication of success or failure) can be displayed on a display device of the pen.

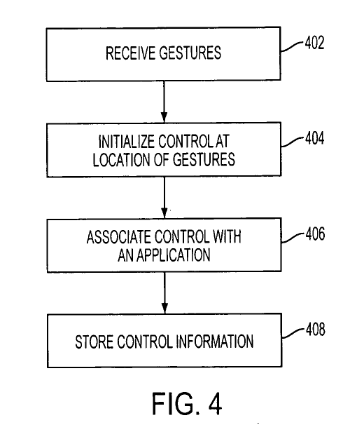

FIG. 4 illustrates an embodiment of a process for recognizing and initializing a user-created control. In this process, a user makes gestures with the smart pen 100 on dot-enabled paper 50 to form a control. While making the gestures, the user can draw the control on the paper 50 with the marker 205 so that it will be recognizable to the user in the future. An example control is a cross comprising two perpendicular line segments (other control shapes are described below). The smart pen 100 receives 402 these gestures. In one embodiment, the smart pen 100 automatically recognizes the gestures as a control. In one embodiment, the user makes an additional signaling gesture after drawing the control to signal to the smart pen 100 that the previous gestures comprised a control. For example, a signaling gesture may comprise double-tapping the smart pen 100 in the center of the newly drawn control.

The pen-based computing system initializes 404 the control at the location of the received gestures. The system recognizes the type of control based on the shape or nature of the gestures. The control is associated 406 with an application (such as the currently executing smart pen application) or certain content (such as notes taken on the same page of the control). Various control information is then stored 408, including the type of the control, the location of the control within the dot pattern, and an indication of any applications or content associated with the control. As mentioned above, the control information may be stored on the smart pen 100 or the attached computing device 120. The user-created control can then be activated and used when needed by the user (e.g., as described in FIG. 3).

In one embodiment, control information associated with a control is stored in memory in the pen-based computing system (e.g., in onboard memory 250 or in memory of the attached computing system 120). Control information associated with a control may include the location of the control within the dot-space or dot pattern. Control information may also include a set of possible functions associated with the control and the gestures within the control associated with each function. These functions are also referred to as control inputs.

For example, a control may have functions for starting audio playback, stopping audio playback, fast forwarding audio playback, and rewinding audio playback. To start audio playback, the user taps a particular button within the control. The control information may include an indication of the function for starting audio playback and the associated gesture. In this case, the associated gesture is a tap at the particular location within the control where the button for starting audio playback is located. Gestures associated with functions may also include dragging the imaging device of the smart pen from one location within the control to another location within the control. For example, a control may comprise a slider bar (e.g., a line connecting two points), and a gesture may comprise dragging from one location to another within the slider bar to specify an increase or decrease of a particular quantity or a movement to a particular location within a stream.

The control information may be accessed when determining 304 if a gesture is located within a control and when determining 306 a control input, as described above. Processing 310 the control input may comprise executing a function associated with the control. In one embodiment, the control information for pre-printed controls is pre-loaded into memory of the pen-based computing system. This control information may also be downloaded to the pen-based computing system. The control information for user-created controls may be created in step 404 based on the gestures used to create the control. The pen-based computing system may recognize the type of control based on the received gestures and store 408 the various functions associated with the control type.

Since a user-created control may be drawn somewhat differently from a pre-printed control of the same type, the gestures associated with each of the functions of the control may be somewhat different from the associated gestures for a pre-printed version of the control. Various pattern recognition algorithms may be used to compare the user-created control with an exemplary pre-printed control and to determine the appropriate gestures to associate with the various functions of the user-created control. For example, in a pre-printed version of a control, a particular function may be associated with a tap 20 millimeters to the left of the center of the control, but in a user-created version of the control that is drawn slightly differently, a particular function may be associated with a tap 30 millimeters to the left of the center of the control.

### Examples of Controls

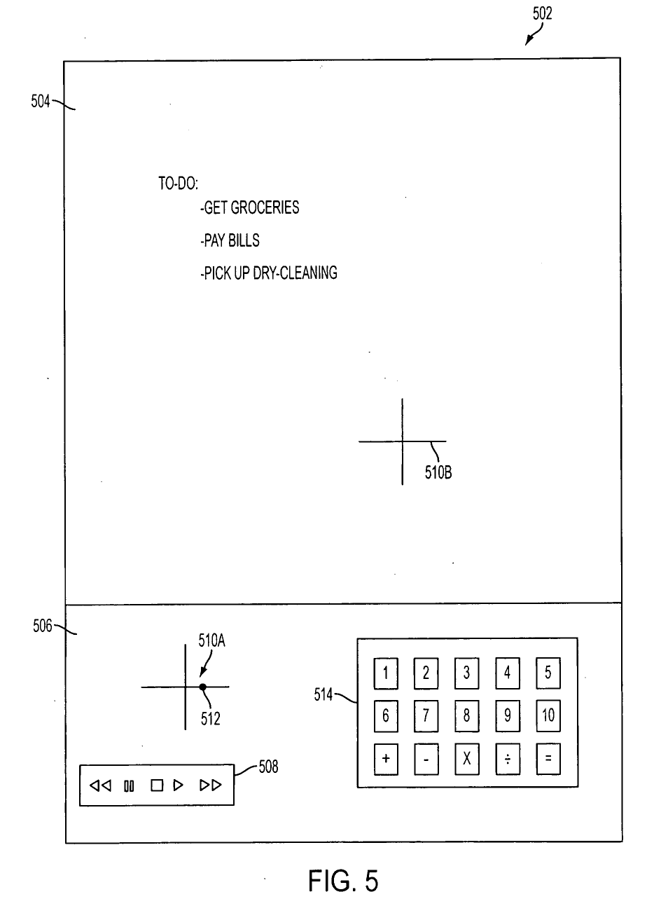

FIG. 5 illustrates an example of a sheet of dot-enabled paper 502 for receiving control inputs through controls. The dot-enabled paper 502 includes a content section 504 and a control section 506. The content section 504 is normally reserved for user-created content to be stored by smart pen applications, while the control section 506 is normally reserved for controls (with exceptions as discussed below). If the user is writing with the smart pen 100 in the content section 504, the writing data is normally provided to a currently active smart pen application. In the example in FIG. 5, the user has taken notes regarding “to-do” items in the content section 504. These notes are recorded and stored by a note-taking application running on the smart pen.

In one embodiment, the control section 506 includes controls pre-printed on the dot-enabled paper 502, such as the controls 508 and 510A. The dot pattern in the control section enables the smart pen to determine 304 if the smart pen is positioned at a particular control in the control section 506. The smart pen may have been previously provided with control information for the controls, as described above. Control information for a control may include the location of the control relative to the dot pattern.

As described above, the user may provide control inputs by making a gesture within a control. For example, if the smart pen 100 is currently playing back an audio recording, the user may stop recording by tapping with the smart pen on the “stop button” (i.e., the square) on the audio control 508. The user may tap other parts of the audio control to pause, fast forward, or rewind through the audio, for example.

Another embodiment of a control is five-way controller 510A, represented on the paper by a cross (two perpendicular lines). The ends of the cross correspond to control inputs for moving up, down, left, and right, and the center of the cross corresponds to a selection or confirmation command. The user can issue these control inputs by tapping on these portions of the cross. The smart pen imaging system 210 and the pen-down sensor 215 provide inputs for the smart pen 100 to determine the location of the taps. The lines of the control can be solid black lines, so that when a user taps or drags on the control, the ink marks from the marker 205 do not change the appearance of the control. The black lines used to represent the active portions of the control thus hide ink marks left behind by frequent use.

Another embodiment of a control is a calculator control 514. The calculator control 514 includes various buttons for entering arithmetic operations by tapping the smart pen on the calculator buttons. The result of the arithmetic operation can be displayed on the display 235 of the smart pen or can be output in audio format through the speaker 225 of the smart pen, for example.

In one embodiment, a plurality of sheets of the dot-enabled paper 502 are provided together, such as in the form of a notebook or notepad. In such an embodiment, the content section 504 of the paper 502 may be printed with different dot patterns to allow the pen to differentiate between different pages of the notebook. But if the control section 506 of the paper includes the same pre-printed controls for each sheet of the paper 502, then this control section 506 can be printed with the same dot pattern on each page. In this way, a control in the control section 506 can be associated with just one small area of the dotted pattern for the entire notebook, rather than being associated with a different area of the pattern for each page of the notebook.

Controls may also be printed on stickers that can be attached to a writing surface 50, where the stickers are dot-enabled. In this case, each sticker has its own control area recognized by the smart pen. Controls may be printed on or embedded in the screen of a computing device, such as the screen of a personal computer or mobile phone, where the screen also includes a dot pattern. Controls may also be located on the case of the smart pen 100, on docking stations 110, or on other peripherals.

### User-Created Controls

As described above, the user can create controls. This may be useful if a particular control desired by the user is not pre-printed. For example, a user can create a five-way controller 510 by drawing a cross and then double-tapping in the center of the cross. The smart pen 100 receives 402 the gestures corresponding to the cross and the double-tap, and then initializes 404 the cross as a five-way controller.

In one embodiment, a user-created control needs to be drawn in a portion of the dot paper or screen that is reserved for controls, such as region 506. In other embodiments, the user may be able to create a control anywhere, including regions of the paper or screen that normally contain content, such as region 504. An example of this is five-way controller 510B. When the user draws the cross in a content region 504, the smart pen 100 may tentatively send the received gestures comprising the cross to a currently running application such as a note-taking application. When the user double-taps in the center of the cross, the smart pen 100 is made aware that the gestures comprised a control. The smart pen 100 may then initialize 404 the control and notify the note-taking application to ignore the cross and avoid storing the control as part of the user's notes.

Other controls, such as the calculator control 514 or audio playback control 508 can also be user-created.

Five-Way controller

In one embodiment, the five-way controller 510 described above is enhanced to provide for a greater range of control inputs from the user. As mentioned above, the user can tap on the endpoint of one of the four directional arms or tap the center of the controller. The center of the controller can have various application-dependent meanings, such as selection or confirmation.

A user can tap along either axis of the control to jump to a relative setting. For example, tapping at point 512 of the horizontal axis, two-thirds of the distance of the line segment from the left end, can set a relative value. It can set the audio playback volume to be two-thirds of the maximum volume, or can jump to an entry in an alphabetical listing of phone numbers that is two-thirds from the first entry to the last entry.

In one embodiment, a user taps-and-holds at a location on the controller to repeat or increase the effect that is achieved by tapping at that location. For example, a user taps-and-holds an endpoint of the controller to issue repeated commands to move in the direction corresponding to the endpoint. The user may also drag along an axis to move back and forth through a stream or a list. To drag along an axis, the user places the point of the smart pen at a location on the axis, holds it to the paper, and moves it along the axis. The user may scrub an audio file or move through a list of items, for example.

The two axes of the controller 510 form a two-dimensional space that a user may tap to select a position. This can be useful in certain games, or to set values for two variables at once. For example, the two variables can correspond to the distance of the user's tap from the two axes. The user can tap or drag between several positions in sequence, for example to enter a secret password or to invoke a pre-determined shortcut or macro.

The smart pen can also be “flicked,” where it is applied to the paper, moved in a particular direction, and the released from the paper. A user flicking the smart pen along an axis of the controller can indicate the speed with which to move through a long list or array. A user can also flick-and-hold, where the user flicks the pen along an axis of the controller to begin rapid scrolling through a list, and then touches the pen down to stop the scrolling at the current location. Flicking, and other movements of the smart pen, can be detected through various inputs of the smart pen such as the imaging device and the pen-down sensor.

### Use of the Five-Way Controller in Different Modes

As mentioned above, the five-way controller 510 can be used to specify a variety of control inputs depending on the current application and the state of the current application. Examples of control inputs provided through the five-way controller when the smart pen is in various application states, or modes, are described below.

Main Menu Mode: In this mode, the five-way controller is used to browse a menu of available files and applications on the smart pen. Tapping at an endpoint of the controller can navigate through menu options. Tapping at the center of the controller can select a current menu option. Once selected, a file or application can be launched, deleted, shared, uploaded, or queried for metadata such as the file's creation date, type, or size. The possible file operations can be selected through a secondary menu that appears when a file is selected, or through a known smart pen command (such as double tapping).

Application Menu Mode: Within an application, the five-way controller can be used to navigate menus and options that apply to that application. Options and features can be invoked and cancelled. The five-way controller is used to input user responses to dialogs and other application queries.

Controller Mode: In certain applications, the five-way controller can be used as a real-time controller. For example, during a sidescroller game, the arms of the five-way controller are used to move the player's ship up and down on the display, or to fire guns or lay mines. The motion can be achieved by the user tapping on the endpoints, or using other methods described above, such as tap-and-hold or tap-and-drag. As another example, during audio playback, the user can use the five-way controller to pause audio, resume audio, jump forward or back within the audio, set bookmarks, or turn speedplay on and off.

The five-way controller can be used in the above modes on the smart pen and on a computer or mobile phone. For example, a user with a wireless smart pen that is connected to a computer or mobile phone can use a pre-printed controller or a user-created controller to engage any one of the above modes to access, launch, delete, share, or upload an application on the computer or mobile phone, among other uses. The pre-printed or user-created controller can be located on the screen of the computer, mobile phone or other computing device. The controller can be used to navigate on any screen based device, such as scrolling through lists or web pages or navigating a map or game.

### Navigating Through Two-Dimensional Space

The five-way controller can be used to navigate through hierarchical menus within an application. Moving up and down using the controller can navigate through a list of options, choices, or features that are at the same level in the menu hierarchy. Moving to the right goes deeper in one particular area, moving down in the hierarchy. This can launch an application, open a folder, or invoke a feature. Moving to the left moves up in the menu hierarchy, such as exiting an application, moving to an enclosing folder, or stopping a feature from running. Upon a movement in any direction, the smart pen 100 can provide feedback to the user, such as visual feedback in the pen's display and/or audio feedback via the pen's speaker.

For example, in a file system explorer application, the user can move through the file system hierarchy using the five-way controller. Suppose the user is in a particular folder containing files and subfolders. Up and down commands issued through the controller allow the user to change the currently selected item in the folder. A right command goes into the selected item. If the item is an application, it is launched. If the item is a subfolder, then the subfolder is opened. A left command closes the current folder and moves up a level, opening the folder that contains the current folder.

Navigation with the five-way controller can be similarly used to respond to user queries. For example, given the query, “Are you sure you want to delete this file?”, a right command means “yes” or “continue” or “invoke this feature,” while a left command means “no” or “cancel” or “take me back to the preceding option branch.”

Association of a Control with an Application

In one embodiment, a control input provided through a control, such as a “navigate left” input provided through a five-way controller, is applied to the currently running application, regardless of the application that was running when the control was created or first used. For example, if the five-way controller was created or first used when the user was in an audio playback application, the same five-way controller can later be used in a note-taking application (though the control may be used differently in the two applications). In one embodiment, if there are multiple five-way controllers available to a user (at different locations on dot-enabled paper), any controller can be used with the current application.

In one embodiment, some or all controls remain associated with a particular application or content based on when the control was created or first used and/or based on its location. A control may become associated 406 with a particular application based on these or other factors. For example, if a control is created when a certain application is running, that control remains associated with that application. If that control is used when another application is running, then any control input received from that control may be ignored, or the control input may cause the application associated with that control to begin running. A control can also be associated with particular content. For example, a control located on a page of notes can begin playback of audio associated with that page when the control is used. Content associated with a control may be stored with other control information in step 408.

In another variation, a control retains information from the last time it was used. When a user returns to the control, the user is taken back to the most recent menu or context associated with the control, so that the user does not need to navigate back to the previous menu or context. In this embodiment, the control information stored in step 408 also includes an indication of the most recent usage context of the control.

### SUMMARY

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium, which include any type of tangible media suitable for storing electronic instructions, and coupled to a computer system bus. Furthermore, any computing systems referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method for receiving inputs through controls, the method comprising:
digitally capturing a writing gesture made on a writing surface using a smart pen device;
identifying a control on the writing surface, the control at least partially corresponding to a location of the writing gesture on the writing surface;
identifying an application associated with the control based on stored control information describing the identified control;
determining a control input based on the identified control and the writing gesture; and
responsive to the control input, switching to the identified application and executing a command in the identified application running on the smart pen device or an attached computing system.

2. The method of claim 1, wherein the application associated with the control is the application that was active when the control was first used.

3. The method of claim 1, further comprising:
identifying content on the writing surface associated with the control based on the stored control information;
wherein the executed command performs an operation on the identified content.

4. The method of claim 1, wherein executing the command further comprises:
presenting a result of the command to the user using an output device of the smart pen device.

5. The method of claim 4, wherein the output device comprises a display of the smart pen device.

6. The method of claim 1, wherein executing the command further comprises:
presenting a result of the command to the user using haptic feedback through the smart pen device.

7. The method of claim 1, wherein the command comprises navigating to a menu item in a menu of the application.

8. The method of claim 1, wherein the application comprises a playback application, and wherein the command comprises starting or stopping playback.

9. A method initializing a user-created control, the method comprising:
digitally capturing a writing gesture made on a writing surface using a smart pen device;
recognizing that the writing gesture comprises a control, the recognizing based on a pattern of the writing gesture;
determining a type of the control based on the pattern of the writing gesture;
determining a location of the control based on the location of the gesture on the writing surface;
determining an application associated with the control, where the application associated with the control is a currently running application; and
storing the location of the control, the type of the control, and the application associated with the control in a memory of the smart pen device.

10. The method of claim 10, wherein recognizing that the writing gesture comprises a control further comprises:
identifying a signaling gesture as a part of the writing gesture.

11. A system for providing instruction, the system comprising:
a smart pen device comprising:
a processor;
a storage medium;
a gesture capture system configured to capture a writing gesture made on a writing surface; and
instructions contained on the storage medium and capable of being executed by the processor, the instructions for identifying a control on the writing surface, the control at least partially including the location of the writing gesture on the writing surface, for identifying an application associated with the control based on stored control information describing the identified control, for determining a control input based on the identified control and the writing gesture, and for, responsive to the control input, switching to the identified application and executing a command in the identified application running on the smart pen device.

12. The system of claim 11, wherein the application associated with the control is the application that was active when the control was first used.

13. The system of claim 11, wherein the instructions are further configured for identifying content on the writing surface associated with the control based on the stored control information and wherein the executed command performs an operation on the identified content.

14. The system of claim 11, wherein executing the command further comprises:
presenting a result of the command to the user using an output device of the smart pen device.

15. The system of claim 14, wherein the output device comprises a display of the smart pen device.

16. The system of claim 11, wherein executing the command further comprises:
presenting a result of the command to the user using haptic feedback through the smart pen device.

17. The system of claim 11, wherein the command comprises navigating to a menu item in a menu of the application.

18. The system of claim 11, wherein the application comprises a playback application, and wherein the command comprises starting or stopping playback.
